(19) United States
(12) Patent Application Publication
(10) Pub. No.: US 2012/0127632 A1
(43) Pub. Date: May 24, 2012

(54) EXTENDED LIFE CAPACITORS

(75) Inventors: David A. Evans, Seekonk, MA (US); Jeffrey N. Reardon, Wakefield, RI (US); David I. Zawacki, Providence, RI (US)

(73) Assignee: EVANS CAPACITOR COMPANY, East Providence, RI (US)

(21) Appl. No.: 12/949,962

(22) Filed: Nov. 19, 2010

(51) Int. Cl. H01G 9/022

(52) U.S. Cl. 361/504

(57) ABSTRACT

Capacitors employing liquid or gel electrolytes have their useful lifetime significantly extended by including, in the electrolyte, a binary mixture of transition metal ion species. Each species has at least two distinct oxidation states when dissolved in the electrolyte. The interaction of the mixture of ion species reduces the potential of the cathode and maintains the potential of the cathode below the hydrogen potential to prevent the reduction of hydrogen ions and the formation of hydrogen. The binary mixture of transition metal species reduces the cathode potential by oxidation of the transition metal species at the anode and reduction of the transition metal species at the cathode. Thus, the rate of decrease in capacitance, increase in equivalent series resistance, and swelling of the capacitor are suppressed. In addition, the ratio of capacitor aging to the quantity of charge passed by the capacitor is decreased by at least a factor of two as compared to previous known extended life capacitors.

The present invention concerns capacitors including liquid and gel electrolytes and that have significantly extended useful lifetimes.

Among the kinds of capacitors employing liquid and gel electrolytes are double layer capacitors, electrolytic capacitors, and hybrid capacitors. Traditional double layer capacitors employ paste electrodes, typically including finely divided carbon particles, and a separator saturated with a liquid electrolyte. The electrolyte is typically an aqueous solution of sulfuric acid. An example of such a double layer capacitor is described in U.S. Pat. No. 3,536,963. Double layer capacitors provide relatively high capacitances, but have a limited frequency response range.

Electrolytic capacitors employing liquid electrolytes are represented by so-called tantalum wet slug capacitors and aluminum capacitors. An early example of a wet slug tantalum capacitor is described in U.S. Pat. No. 4,523,255. In tantalum wet slug capacitors, the cathode consists of a cup or can of tantalum or having a tantalum coating on the inside surface. The anode is usually sintered tantalum powder that has been compressed before sintering. Tantalum readily forms a native oxide so that both the inside surface of the can and the outside surface of the sintered anode are electrically insulating. The oxide on the anode can be thickened anodically to increase the voltage rating of the capacitor. An electrolyte, such as sulfuric acid, is added to the can and is in contact with both the inside surface of the can and the sintered anode. The electrolyte actually forms one capacitor at the cathode and another capacitor at the anode because of the intervening native oxides.

Hybrid capacitors employ the same kind of anode as a conventional tantalum wet slug capacitor. The cathode is an electrochemical capacitor cathode. The anode may again be sintered tantalum particles producing a porous anode structure with a native oxide coating. That oxide coating may be increased in thickness anodically to increase the voltage rating of the capacitor. The cathode, which may be a coating on the inside surface of the container of the capacitor, may be an electrically conductive oxide coating, for example, ruthenium oxide. As in an electrolytic capacitor, the capacitance produced results from a combination of the capacitances formed (i) at the electrically insulating coating of the anode and the electrolyte and (ii) the electrically conducting oxide of the cathode and the electrolyte. An example of a hybrid capacitor is described in commonly assigned U.S. Pat. No. 5,369,547, which is incorporated into this description by reference. While a variety of electrolytes can be employed in hybrid capacitors, a traditional electrolyte is an aqueous solution of sulfuric acid.

Each of the capacitors described in the previous paragraphs has its own characteristics and failure mechanisms, although some of the failure mechanisms have a common origin. According to one common measure, a capacitor is considered to be no longer useful when changes in various characteristics exceed respective thresholds. See Evans, “Tantalum Hybrid® Capacitor Life Test,” Inter'l Symposium on Double Layer Capacitors and Similar Energy Storage Devices”, December 2002, Deerfield Beach, Fla., and Zawacki et al., “Extended Life Tantalum Hybrid Capacitor,” Seminar on Double Layer Capacitors, December 2005. Deerfield Beach, Fla., which are incorporated into this description by reference.

Measurements of various characteristics of a liquid or gel electrolyte capacitor are made to determine whether of the capacitor's useful life was ended. For example, if a capacitor loses about 20% of the nominal original capacitance, the capacitor's useful life is considered ended. Leakage current that flows through the capacitor also provides an indication of capacitor aging and failure. The inventors have concluded that the quantity of charge that flows over time, i.e., the integral of the leakage current as a function of time, in a liquid or gel electrolyte capacitor is roughly proportional to the age of the capacitor.

Ideally, as an electrical circuit component, a capacitor has no resistance and is strictly a reactive element. However, in practice, every capacitor has an ohmic component that is referred to as the equivalent series resistance (ESR). The ESR is typically attributable to the electrical resistances of the electrolyte, the electrical resistance of the cathode and anode, and the contact resistances of the internal connections of the capacitor. As a capacitor ages, the ESR usually increases. A common measure of the end of the useful life of a capacitor is a doubling of the ESR, i.e., an increase of 100%, from the initial value. That measure of the end of useful capacitor life is an alternative to or supplement of the decrease in the capacitance and the quantity of charge passed by the capacitor, which also signify aging.

The electrochemistry associated with the aging of capacitors employing liquid and gel electrolytes can result in the production of hydrogen ions (protons) within the capacitors. The generation of atomic hydrogen is believed to result from the flow of leakage current in the capacitor. That leakage current transports electrons to the cathode where the electrons accumulate, raising the electrochemical potential of the cathode. If that potential rises to the so-called hydrogen potential, a potential of about 1.2 to 1.3 volts, the hydrogen ions may be reduced at the cathode, causing an irreversible generation of hydrogen. The hydrogen may coalesce into bubbles within the electrolyte. The hydrogen may also interact with the cathode, reducing the efficiency of the cathode and increasing the ESR. Further, when the capacitor package is sealed in order to prevent loss of electrolyte, the hydrogen evolution increases the internal pressure within the capacitor. If the pressure within the capacitor rises sufficiently, the package of the capacitor can be distorted, commonly referred to in the art as swelling, or even burst. Preferably, swelling is avoided. However, swelling is a sensitive indicator of capacitor aging. Thus, declining capacitance, increasing ESR, and package swelling all provide information for observing aging and determining the end of the useful life of a capacitor with a liquid or gel electrolyte. The quantity of charge passed by a capacitor also indicates capacitor age.

Because capacitors are very important circuit components and have, potentially, shorter lifetimes than other passive circuit components, there have been numerous attempts to extend the lifetimes of capacitors that include liquid and gel electrolytes. One notable attempt to extend the lifetime of electrolytic capacitors includes adding “depolarizing agents” to the electrolyte. The depolarizing agents attempt to reduce the potential difference between the cathode and the electrolyte. If that potential difference can be maintained below the hydrogen formation potential, then the evolution of hydrogen will be suppressed and there should be no swelling of the capacitor package. However, typically, depolarizing agents are consumed in providing the depolarizing function. As a result, the lifetime extension provided by depolarizers is limited.

Examples of the addition of one or two depolarizing agents to the electrolyte of a wet slug capacitor are described in U.S. Pat. Nos. 2,710,369 and 2,778,979. According to the first of those patents, the cathode of the capacitor is copper or silver and is opposite a tantalum anode. Sulfuric acid is the electrolyte. Copper ions were added to the electrolyte, reducing electrical losses at the cathode-electrolyte interface and thereby increasing capacitance. A capacitor to which copper ions were added reportedly had increased energy storage. The second of the cited patents expressly describes the suppression of hydrogen evolution, resulting in extended capacitor lifetime. The reduction in hydrogen generation is evidenced by decreased leakage current according to that patent. Similar description appears in U.S. Pat. No. 4,016,465 which advocates forming a layer of copper telluride, copper selenide, or copper sulfide on the inside surface of a copper capacitor container as a source of a depolarizing agent.

Use of silver as a depolarizing electrolyte additive, and of copper and silver, in combination, as depolarizing electrolyte additives are described in U.S. Pat. Nos. 2,616,953 and 4,159,509. As acknowledged in the latter patent, the metal ions within the electrolyte can result in plating of a metal within the capacitor. Short-circuiting of the electrodes can result from the plating, terminating capacitor life. That plating consumes the depolarizing additive or additives, reducing depolarizing efficiency, even if there is no short circuit. The possibility that these metals can “plate out,” producing a short circuit risk, flows from their single soluble oxidation state in traditional electrolytes, such as sulfuric acid.

U.S. Pat. No. 3,751,797 describes the addition of metal ions to an electrolyte in an electrolytic capacitor having a silver or copper cathode and a sintered tantalum anode. Silver ions are supplied by dissolving silver sulfate in a sulfuric acid electrolyte. In addition to the silver ions, other metallic ions may be present in the sulfuric acid electrolyte. Vanadium, chromium, manganese, and iron ions are mentioned as respective second species of a binary system that employs silver ions as the primary species. The additive ions are said to suppress the formation of hydrogen by enhancing electrolytic deposition of silver onto the cathode. That plating is driven by leakage current and, again, that plating both consumes a depolarizing additive and raises the possibility of short circuiting within the capacitor.

### SUMMARY OF THE INVENTION

Capacitors employing liquid and gel electrolytes are vital components in electrical circuitry. Those capacitors provide relatively high capacitances that cannot be achieved in integrated circuit capacitors. Further, those capacitors are subject to failure before the likely failure of other passive and active circuit components. Therefore, the present invention is directed to producing such capacitors but with significantly extended lifetimes.

A capacitor according to the invention includes a cathode and an anode. The anode is typically made of a valve metal that includes a dielectric coating. A liquid or gel electrolyte is in contact with the cathode and the anode, at the dielectric coating or coatings, if present. The electrolyte includes a binary mixture of transition metal ion species. Each species has at least two distinct oxidation states when dissolved in the electrolyte. The interaction of the mixture of ion species reduces the potential of the cathode and maintains the potential of the cathode below the hydrogen potential to prevent the reduction of hydrogen ions and the formation of hydrogen. Thus, the rate of decrease in capacitance, and the rate of increase in ESR and the swelling of the capacitor package are suppressed. The binary mixture of transition metal species is believed to reduce the cathode potential by transporting charge between the anode and the cathode, opposite to the direction of leakage current flow, by oxidation of the transition metal species at the anode and reduction of the transition metal species at the cathode.

### BRIEF DESCRIPTION OF DRAWING FIGURES

FIG. 1 is a schematic cross-sectional view of the mechanical structure of a known wet slug electrolytic capacitor to which the invention may be applied.

FIGS. 2 and 3 are schematic exploded and cross-sectional views, respectively, of a hybrid capacitor structure to which the invention may be applied.

### DETAILED DESCRIPTION

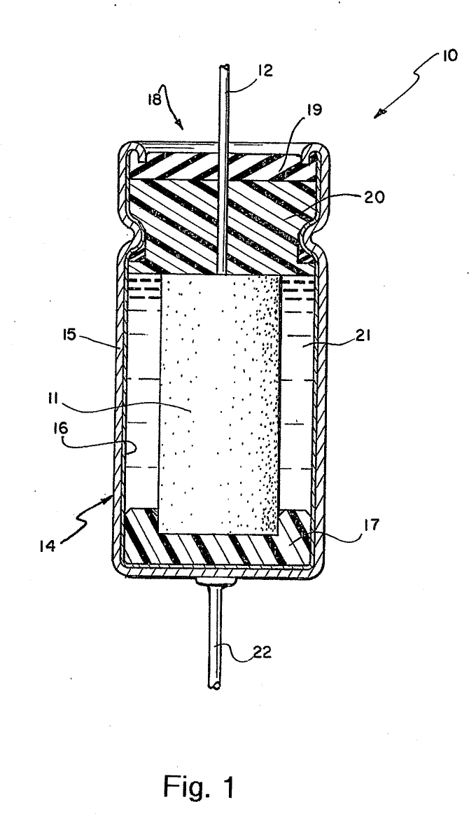

The present invention relates to capacitors employing liquid or gel electrolytes and extends the life of those capacitors by adding a binary mixture of transition metal ions to the electrolyte. While the invention is not directed to a particular mechanical capacitor structure, FIG. 1 illustrates, in a cross-sectional view, an exemplary mechanical structure of a wet slug tantalum capacitor with a liquid electrolyte to which the invention may be applied. The mechanical structure illustrated in that figure, and in the other figures described below, in no way limits the scope of the invention and is not part of the invention. FIG. 1 is taken from U.S. Pat. No. 4,159,509 for purposes of providing an example of a mechanical structure of a wet slug capacitor.

In FIG. 1, the capacitor includes an anode 11 which may be a valve metal electrode, such as the kind of anodes that are employed in wet slug capacitors. Valve metals include tantalum, hafnium, niobium, zirconium, aluminum, tungsten, and titanium. Metals in this group, such as tantalum, that form native electrically insulating oxides are particularly useful as electrodes, both anodes and cathodes, in wet slug capacitors. Thus, the metal case 15 of the illustrated capacitor may function as the cathode 14 of that capacitor. A cathode lead 22 is bonded to the cathode. An anode lead 12 is bonded to the anode 11. The anode is held in place within the case 15 by an electrically insulating spacer 17 that receives the end of the anode that is opposite the end including the anode lead 12.

At the end of the anode 11 including the anode lead 12, an electrically insulating spacer contacts the anode. The case 15 is typically circumferentially crimped to engage and hold in place the end of the anode including the anode lead 12. The open end of the case, in the illustrated embodiment, is bent to engage the spacer 20 and seal the case against escape of the electrolyte. The electrolyte 21 fills the space between the outside surface of the anode 11 and the inside surface of the case 15. If, for example, the capacitor is a hybrid capacitor, then the cathode may include a conductive porous oxide coating 16 on the inside surface of the case 15. In a capacitor according to the invention having the mechanical structure shown in FIG. 1, the binary mixture of transition metal ions, i.e., species, extending the life of the capacitor, are dissolved in the electrolyte 21. Typical liquid electrolytes in capacitors according to the invention are aqueous solutions of acids, such as sulfuric acid and hydrochloric acid. The electrolyte and electrode materials are chosen to be compatible with each other and the case of the capacitor.

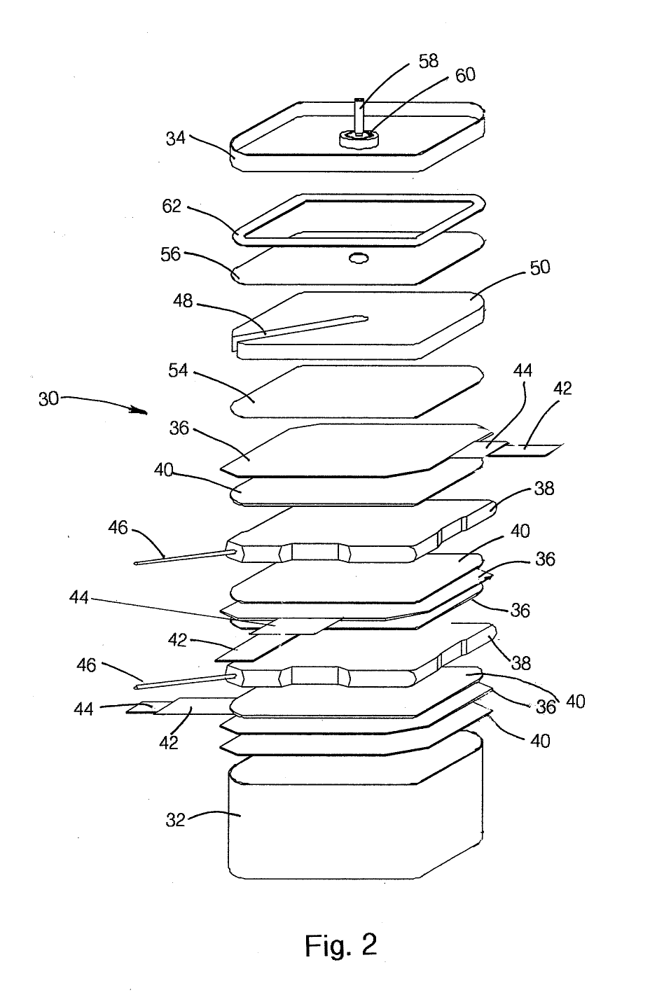

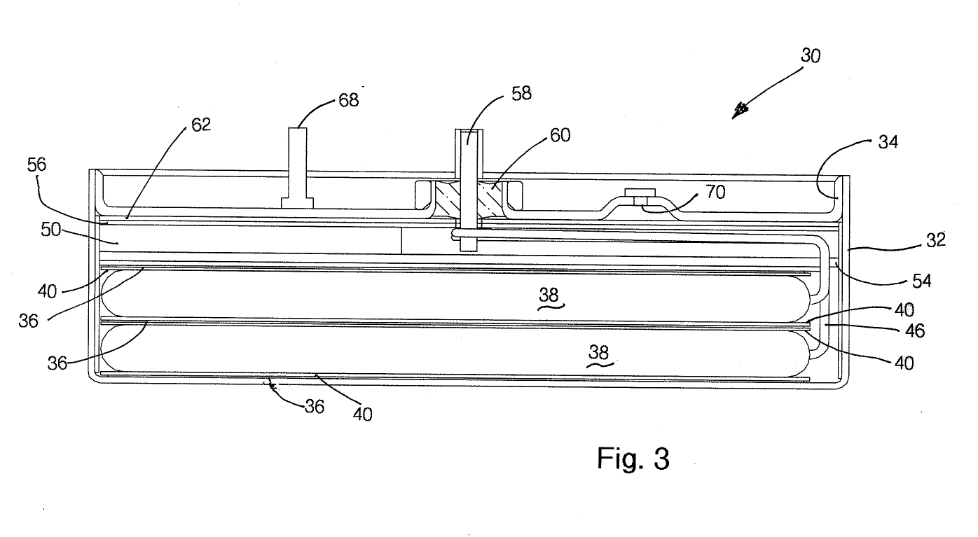

FIGS. 2 and 3 are schematic exploded and cross-sectional views of the structure of a commercially available hybrid capacitor and to which the present invention may be applied. The illustrated capacitor structure includes two anodes and multiple cathodes. The same general structure can be produced with a larger or smaller number of cathodes and anodes. The anodes are electrically connected in parallel to increase the capacitance of the capacitor. Although not preferred, alternatively, the anodes could be electrically connected in series to increase the voltage rating of the capacitor. However, preferably, the voltage rating is established by controlling the thickness of the oxide coating of the anode or anodes.

The capacitor 30 shown in FIGS. 2 and 3 can have essentially any shape, in a plan view, transverse to the view of FIG. 2, for example a circular or polygonal shape. An example of the latter shape is shown in FIG. 2. The capacitor 30 includes a case 32, preferably a conductive metal. The case 32 is sealed by a header 34. The header 34 is preferably welded to the case.

Three cathodes 36 are alternately laminated with two anodes 38. Each cathode is preferably a metal foil coated, at least on the surface or surfaces facing one of the anodes 38, with an electrically conductive oxide typically employed an electrochemical capacitor electrode. That coating is, preferably, ruthenium oxide (RuO₂). The anodes 38 are pellets or bodies of sintered particles of a valve metal, preferably tantalum, that forms a native oxide on the surfaces of the particles. The oxide thickness may be anodically increased to increase the voltage rating of the capacitor. Respective ion conductive separators 40 are interposed between the opposing faces of the cathodes and the anodes. The lowermost cathode 36 within the case 32 is in contact with a separator 40. Each of the cathodes includes a protecting electrically conductive tab 42, with an insulator part 44, this is folded against the inside surface of the case 32 and electrically connected to the case so that the case forms one electrical terminal, namely the negative terminal, of the capacitor. Likewise, each of the anodes includes a projecting lead 46 that is bent toward the header 34, but electrically insulated from the case 32. The projecting leads 46 pass through a diagonal slot 48 in an electrically insulating polymeric spacer 50. The insulating spacer is further separated from the uppermost electrodes in the case by an insulating sheet 54 that insulates the anode leads from the adjacent cathode. A second electrically insulating sheet 56 is interposed between the spacer 50 and the header 34. That sheet 56 includes a central hole for passage of a pin 58 that functions as the second terminal, namely the positive terminal, of the capacitor. The post 58 is held in an opening of the header 34 by a glass-to-metal seal 60. The leads 46 from anodes 38 are wound about and bonded to the lower end of the pin 58. An annular gasket or spacer 6, located between the header and the insulating sheet 56, cushions the assembly while the header 34 is welded to the case 32.

A post 68, see FIG. 3, that provides a negative terminal of the capacitor, is welded to the header 34. The header 34 also includes a further opening 70, which is sealed in the completed capacitor. The opening is employed for vacuum infusion of the liquid or gel electrolyte into the case 32 of the capacitor, so that the electrolyte is in contact with the cathodes 36, the anodes 38, and the separators 40.

An initial concept for extending the life of a capacitor was the dissolution of a transition metal compound in the electrolyte of a capacitor. The transition metal of the compound would be chosen to have two oxidation states within the electrolyte. The oxidation state of the transition metal ion would change, based upon oxidation at the anode and reduction at the cathode. The ionized species would transit through the electrolyte between the cathode and the anode, transporting electrical charge. The reduction reaction at the cathode would prevent reduction of protons that might produce hydrogen. However, upon testing, the results, using, for example, iron and vanadium, individually, as the single transition metal ion, were not successful. At relatively low concentrations of these individual species, the effect of the species on extending capacitor life was negligible. At higher concentrations of the species, anode deterioration was observed. In these tests, transition metals were chosen as the species because many transition metals include at least two different oxidation states that are soluble in traditional capacitor electrolytes, such as sulfuric acid. Candidate transition metals that, in the form of compounds, may be dissolved in an electrolyte and have, as dissolved in the electrolyte, more than one oxidation state include chromium, cobalt, copper, iron, manganese, mercury, nickel, rhenium, ruthenium, and vanadium.

In spite of the disappointing results in attempting to extend capacitor lifetime by dissolving a single transition metal species in the electrolyte of the capacitor, surprising and unexpected results were achieved when two different transition metal species, each species having at least two oxidation states that are stable within the electrolyte, were added to the electrolyte. This mixture is referred to here as a binary mixture of transition metal species, meaning that two transition metal species are present in the electrolyte solution. This electrolyte solution, with the two transition metal ion species, has the advantage, not present in a depolarizer, of not being consumed in the course of transporting electrical charge between the anode and cathode. Further, if the oxidation state never declines to zero for the transition metal species, there is little likelihood that the metal species will become a metal atom that could plate onto a capacitor part and possibly cause a short circuit.

In some embodiments of the invention, the liquid electrolyte is an aqueous solution of 38 wt % of sulfuric acid. The following examples and measured data for embodiments of the invention and comparative capacitors having no transition metal additive or only a single transition metal additive, use that electrolyte. When there is no additive, then the electrolyte is the 38 wt % sulfuric acid solution. This liquid electrolyte, and other acidic electrolytes, may be converted to gels by the addition of silica. The results for a gelled electrolyte are expected to be the same as those reported here for a liquid electrolyte.

In order to determine the effectiveness of the invention in extending the life of hybrid tantalum capacitors, a large number of hybrid tantalum capacitors employing ruthenium oxide (RuO₂)cathodes and sintered tantalum anodes were prepared and subjected to aging and life tests to observe the aging process and capacitor lifetime. The capacitors were tested in groups based on their rated voltages. The rated voltage was established by forming the oxide layer of the anode to a particular thickness for each rated voltage, as is known in the art. Larger thickness results in a higher voltage rating. The tested capacitors were similar in structure to those illustrated in FIGS. 2 and 3 and had a length, sometimes referred to as the height, measured axially, from the top to the bottom of the capacitor, i.e., perpendicular to relatively planar anodes and cathodes in the configuration of FIGS. 2 and 3.

In the aging and life tests, a constant DC voltage was applied to each capacitor. In order to accelerate aging of the capacitors being tested, the tests were carried out at elevated temperatures. In the first aging test, a voltage equal to the rated voltage of the capacitor was applied to the capacitor, with the capacitor held at a temperature of 85° C. In order to monitor the characteristics of each capacitor, the capacitors were periodically cooled to room temperature and the ESR, capacitance, and swelling, namely any increase in overall height (OAH) of the capacitor, were measured. A second aging test was performed on capacitors according to the invention in which the voltage applied to the capacitor was 60% of the rated voltage while the temperature of the capacitor was 125° C. Again, periodically, the capacitors were cooled to room temperature and measurements of ESR, capacitance, and OAH were made. In all tests, the rated voltages of the capacitors were treated as a parameter. For reasons not presently understood, capacitors at certain rated voltages showed better performance than capacitors with similar structures but with different rated voltages.

Leakage current may provide another indication of capacitor aging. However, leakage current was not measured in the testing that is reported here. The addition of transition metal species to the electrolytes of the capacitors tested may actually increase the quantity of charge passed by the capacitors. However, most of that charge passes without substantial irreversible damage to the cathodes or damage to the anodes of capacitors according to the invention. Further, compared to known capacitors that include electrolyte additives intended to extend the life of those capacitors, there is a much lower rate of any irreversible damage per coulomb of charge that is passed. The proportional relationship between the quantity of charge that is passed by a capacitor to the age of the capacitor depends upon the structure and materials of the capacitor. In capacitors according to the invention, the ratio of capacitor aging to the quantity of charge passed is decreased by a factor of at least two. This improvement is not reflected in the results of the aging and life tests that are appear in the Tables below, but represents a further important advantage achieved in the invention.

When aging tests were carried out on a number of similar capacitors, i.e., with the same internal structure and voltage rating, the changes in capacitance, ESR and OAH were averaged for the group of capacitors. The average changes in capacitance and ESR for various aging test conditions are expressed in percentages in the Tables supplied below with respect to the examples of capacitors according to the invention and comparative capacitors. In the Tables, OAH is shown as an absolute change in dimension without reference to the initial axial height of the capacitor package. The magnitude of the dimensional change, not the relative dimensional change, is a more significant characteristic in the applications made of the capacitors. Further, the internal pressure within the capacitor causes a proportional change in height.

The life tests were a continuation of the first aging test. Namely, in those tests the capacitors being tested were subjected to their rated voltages and were periodically cooled to room temperature from 85° C. to measure the changes in capacitance, ESR, and OAH. The purpose of the aging tests is to show, over time, the relative changes in capacitor characteristics. The function of the life tests is to demonstrate how long a capacitor is useful, i.e., has a capacitance that does not fall below 20% of the original capacitance and/or does not suffer a doubling in the ESR. In the life tests, testing was frequently terminated before the threshold changes in capacitance and ESR that indicate failure had been reached. The tests were terminated, in some cases, to disassemble the capacitors and to detect any internal changes. In other instances, although an “end of life” hour duration is indicated in some of the Tables appearing below, there was actually no failure to perform as desired. Rather, the results are, in some instances pertaining to capacitors according to the invention, interim results. In fact, some of the life tests are continuing even as of the filing in the U.S. of this description. Some capacitors that failed, without the minimum change in capacitance or ESR that indicates failure, have failed due to mechanical failures, i.e., mechanisms that do not relate to changes in capacitance and ESR. These results suggest that the maximum possible lifetime extension with respect to the electrochemistry of the capacitors has been achieved in the invention. That lifetime is typically many thousands of hours as compared to a typical lifetime of about 2000 hours for a similar capacitor structure that lacks any transition metal species electrolyte additive. Further, the comparative results show the remarkable effect of using the binary mixture of transition metal additives as compared to using only a single transition metal additive.

In addition to inclusion within the additive of two transition metal species, both having two stable oxidation states when dissolved in the electrolyte, we have found it useful to include a minor amount of a metal complexing agent in the electrolyte. More specifically, improved performance is achieved when the electrolyte contains about 0.1%, by weight, of thiourea, sometimes called thiocarbamide. The role of the complexing agent in extending the useful lifetime of the capacitors is not understood and no theory of its effect is proposed. Other complexing agents besides thiourea may be effective as an electrolyte additive for increasing the lifetime of capacitors with liquid or gel electrolytes and containing a binary mixture of transition metal species.

### Example 1

In the first example of the invention, the transition metal species added to the electrolyte are vanadium and copper. Typically, these species are supplied by dissolving compounds including those metals in the electrolyte which, in the examples, is sulfuric acid. The compounds employed to supply the species in the first example are copper sulfate (CuSO₄) and vanadium pentoxide (V₂O₅). The concentrations of the species, explained here in terms of wt. %, are based upon the weight of the compounds used to supply the species with respect to the total weight of the electrolyte solution. In the capacitors according to the first example, the vanadium concentrations were 0.375 wt. % and 0.75 wt %. The concentrations of copper were 2% and 3%. (A wider range of copper concentrations was used in comparative capacitors.) These concentrations were chosen for the purposes of testing and are not intended to express fixed ranges to which respective concentrations of the species are restricted in capacitors according to the invention. We have found that when the concentration of one or both species is too low, the advantageous effects of the invention are not achieved. Likewise, when the concentrations are excessive, heating of the electrodes has been observed. This heating is believed to produce adverse effects on capacitor performance.

Tables 1-3 below summarize measured results for capacitors according to the first example with respect to comparative capacitors outside the scope of the invention. Table 1 shows a summary of results of aging tests for capacitors according to the first example, including concentrations of vanadium and copper species, as well as entries for capacitors including neither vanadium nor copper as an added species. Where the concentrations of vanadium and copper are indicated to be zero, the electrolyte is simply a 38 wt. % aqueous solution of sulfuric acid without any additives. All of the capacitors according to the first example included 0.1 wt. % of thiourea.

Table 1 illustrates the effects of aging in terms of capacitance change, ESR change, and swelling. Table 1 makes clear that capacitors according to the first example are vastly superior to capacitors including no additives at all. In fact, even for the time periods of the tests indicated in Table 1, the ESR for most of the capacitors lacking any additive rose beyond the threshold for failure.

Table 2 shows comparable measurements, although for both shorter and comparable time periods, in aging tests of capacitors including only vanadium as an added species within the electrolyte, without another transition metal species. Table 2 also includes some entries for capacitors having no transition metal additive in the electrolyte. As in Table 1, many of those capacitors with no transition metal species additive failed within the indicated time periods because their average ESR change exceeded 100%.

Table 3 shows the results of aging tests for capacitors that include only copper as a transition metal species additive in the electrolyte. As in Tables 1 and 2, there are also some entries for capacitors including no transition metal additive in the electrolyte.

Applying the observation that performance of various capacitors seems to be related, in an unknown way, to the voltage ratings of the capacitors, the appropriate comparisons among Tables 1, 2, and 3 are between capacitors with similar voltage ratings. Among the important conclusions that can be drawn from Tables 1-3 is that capacitors according to the invention can perform satisfactorily for more that 6,000 hours when similar, but conventional, capacitors can be expected to have failed in a much shorter time period. Further, comparative capacitors including only vanadium as a single transition metal species in the electrolyte show much more rapid aging in terms of all three measures, capacitance change, increase in ESR, and swelling.

With respect to the capacitors including only copper as a transition metal species additive in the electrolyte, changes in capacitance with aging are comparable or, in some instances, smaller than the changes in capacitance of capacitors employing both copper and vanadium species in the electrolyte. Nevertheless, the deterioration in the ESR is substantially greater when only the copper species is present in the additive. Therefore, these aging tests confirm that superior performance, in terms of aging characteristics, is obtained in capacitors according to the invention including a binary mixture of transition metal species, namely vanadium and copper, in the electrolyte as compared to capacitors that include no such additive or only one of those two transition metal species as an additive.

TABLE 1
Aging Tests
Vanadium + Copper Additive

| | | | | | Average | Average | |
|---|---|---|---|---|---|---|---|
| Rated | | | Test Voltage | | Capacitance | ESR | Average |
| Voltage | V Conc | Cu Conc | and Temp. | Duration | Change | Change | Swelling |
| (volts) | (wt. %) | (wt. %) | (volts/° C.) | (hours) | (%) | (%) | (inches) |
| 50 | 0.375% | 2% | 50 V/85° C. | 3000 | −2.0% | 6.7% | 0.0028 |
| 50 | .75% | 3% | 50 V/85° C. | 3000 | −3.3% | 14.6% | 0.0028 |
| 50 | 0 | 0 | 50 V/85° C. | 2500 | −10.4% | 144% | 0.0698 |
| 50 | 0.375% | 2% | 30 V/125° C. | 3000 | −3.1% | 5.0% | 0.0140 |
| 50 | 0.75% | 3% | 30 V/125° C. | 3000 | −3.1% | 0.1% | 0.0117 |
| 50 | 0 | 0 | 30 V/125° C. | 3000 | −7.4% | 24.8% | 0.0218 |
| 50 | 0.75% | 3% | 50 V/85° C. | 6000 | −4.8% | 16.2% | 0.0035 |
| 50 | 0 | 0 | 50 V/85° C. | 6000 | — | — | — |
| 50 | 0.75% | 3% | 30 V/125° C. | 6000 | −4.5% | 3.2% | 0.0143 |
| 50 | 0.75% | 3% | 50 V/85° C. | 6000 | −4.8% | 17.4% | 0.0035 |
| 80 | 0.375% | 2% | 80 V/85° C. | 3000 | −1.5% | 15.5% | 0.0040 |
| 80 | 0.75% | 3% | 80 V/85° C. | 3000 | −1.4% | 20.1% | 0.0040 |
| 80 | 0 | 0 | 80 V/85° C. | 2500 | −7.6% | 178% | 0.0928 |
| 80 | 0.375% | 2% | 48 V/125° C. | 3000 | −1.0% | 2.4% | 0.0118 |
| 80 | 0.75% | 3% | 48 V/125° C. | 3000 | −0.8% | 0.0% | 0.0110 |
| 80 | 0 | 0 | 48 V/125° C. | 3000 | −1.6% | 8.9% | 0.0158 |
| 80 | 0.75% | 2% | 80 V/85° C. | 6000 | −1.7% | 17.9% | 0.0044 |
| 80 | 0.75% | 3% | 80 V/85° C. | 6000 | −2.1% | 21.2% | 0.0054 |
| 80 | 0 | 0 | 80 V/85° C. | 6000 | — | — | — |
| 80 | 0.375% | 2% | 48 V/125° C. | 6000 | −0.9% | 3.2% | 0.0145 |
| 80 | 0.75% | 3% | 48 V/125° C. | 6000 | −0.6% | 0 | 0.0150 |
| 100 | 0.375% | 2% | 100 V/85° C. | 3000 | −3.2% | 29.8% | 0.0072 |
| 100 | 0 | 0 | 100 V/85° C. | 2500 | 5.9% | 153% | 0.0365 |
| 100 | 0.375% | 2% | 60 V/125° C. | 3000 | −3.0% | 5.5% | 0.0120 |
| 100 | 0 | 0 | 60 V/125° C. | 3000 | −3.1% | 40.8% | 0.0350 |
| 100 | 0.375 | 2% | 60 V/125° C. | 6000 | −2.1% | 3.0% | 0.0178 |
| 100 | 0 | 0 | 60 V/125° C. | 6000 | −3.6% | 20.5% | 0.0435 |
| 125 | 0.375% | 2% | 125 V/85° C. | 2000 | −2.7% | 50.9% | 0.0098 |
| 125 | 0 | 0 | 125 V/85° C. | 2000 | −4.0% | 132% | 0.0285 |
| 125 | 0.375% | 2% | 75 V/125° C. | 3000 | −1.1% | 7.6% | 0.0080 |
| 125 | 0 | 0 | 75 V/125° C. | 3000 | −1.3% | 13.3% | 0.0120 |
| 125 | 0.375% | 2% | 75 V/125° C. | 6000 | −1.4% | 1.9% | 0.0195 |
| 125 | 0 | 0 | 75 V/125° C. | 6000 | −1.7% | 10.2% | 0.0155 |

Capacitors include 0.1% of thiourea only when both vanadium and copper are present.

TABLE 2
Aging Tests
Vanadium Only Additive

| | | | | Average | | |
|---|---|---|---|---|---|---|
| Rated | | Test Voltage | | Capacitance | Average | Average |
| Voltage | V Conc | and Temp. | Duration | Change | ESR | Swelling |
| (volts) | (wt. %) | (volts/° C.) | (hours) | (%) | Change (%) | (inches) |
| 10 | 1.25% | 10 V/85° C. | 2016 | −16.2% | 88.4% | 0.0026 |
| 10 | 0.75% | 10 V/85° C. | 2016 | −17.1 | 85.8% | 0.0024 |
| 10 | 0.25% | 10 V/85° C. | 2016 | −25.5% | 149% | 0.0023 |
| 10 | 0 | 10 V/85° C. | 2016 | −31.9% | 211% | 0.0095 |
| 25 | 1.25% | 25 V/85° C. | 2016 | −7.5% | 61.5% | 0.0020 |
| 25 | 0.75% | 25 V/85° C. | 2016 | −5.2% | 43.8% | 0.0016 |
| 25 | 0.25% | 25 V/85° C. | 2016 | −2.0% | 16.5% | 0.0017 |
| 25 | 0 | 25 V/85° C. | 2016 | −6.3% | 45.5% | 0.0125 |
| 50 | 1.25% | 50 V/85° C. | 2016 | −3.7% | 81.5% | 0.0038 |
| 50 | 0.75% | 50 V/85° C. | 2016 | −5.8% | 102% | 0.0034 |
| 50 | 0.25% | 50 V/85° C. | 2016 | −3.7% | 56.0% | 0.0043 |
| 50 | 0 | 50 V/85° C. | 2016 | −16.6% | 241% | 0.0150 |
| 63 | 1.25% | 63 V/85° C. | 2016 | −2.0% | 47.7% | 0.0035 |
| 63 | 0.75% | 63 V/85° C. | 2016 | −2.6% | 55.2% | 0.0028 |
| 63 | 0 | 63 V/85° C. | 2016 | −7.5% | 183% | 0.0710 |
| 80 | 1.25% | 80 V/85° C. | 2016 | −4.5% | 47.0% | 0.0068 |
| 80 | 0.75% | 80 V/85° C. | 2016 | −3.6% | 43.8% | 0.0088 |
| 80 | 0 | 80 V/85° C. | 2016 | −10.3% | 207% | 0.0330 |
| 100 | 1% | 100 V/85° C. | 2016 | −8.3% | 81.2% | 0.0063 |
| 100 | 0.75% | 100 V/85° C. | 2016 | −5.8% | 51.3% | 0.0067 |
| 100 | 0.5% | 100 V/85° C. | 2016 | −8.0% | 68.5% | 0.0070 |
| 100 | 0.25% | 100 V/85° C. | 2016 | −15.3% | 89.3% | 0.0070 |
| 100 | 0 | 100 V/85° C. | 2016 | −10.1% | 86.8% | 0.0130 |
| 125 | 0.75% | 125 V/85° C. | 2016 | −2.5% | 35.2% | 0.0123 |
| 125 | 0.5% | 125 V/85° C. | 2016 | −2.3% | 31.8% | 0.0140 |
| 125 | 0.25% | 125 V/85° C. | 2016 | −2.3% | 34.9% | 0.0150 |
| 125 | 0 | 125 V/85° C. | 2016 | −4.6% | 75.4% | 0.0215 |
| 10 | 1.25% | 10 V/85° C. | 3504 | −14.4% | 87.6% | 0.0028 |
| 10 | 0.75% | 10 V/85° C. | 3504 | −17.0% | 86.9% | 0.0022 |
| 10 | 0.25% | 10 V/85° C. | 3504 | −22.3% | 133% | 0.0030 |
| 10 | 0 | 10 V/85° C. | 3504 | −38.3% | 272% | 0.0150 |
| 25 | 1.25% | 25 V/85° C. | 3504 | −7.5% | 60.8% | 0.0022 |
| 25 | 0.75% | 25 V/85° C. | 3504 | −5.5% | 38.1% | 0.0016 |
| 25 | 0.25% | 25 V/85° C. | 3504 | −2.8% | 14.0% | 0.0017 |
| 25 | 0 | 25 V/85° C. | 3504 | −12.4% | 92.5% | 0.0160 |
| 50 | 1.25% | 50 V/85° C. | 3504 | −4.6% | 81.5% | 0.0048 |
| 50 | 0.75% | 50 V/85° C. | 3504 | −6.7% | 96.2% | 0.0037 |
| 50 | 0.25% | 50 V/85° C. | 3504 | −4.9% | 51.0% | 0.0747 |
| 50 | 0 | 50 V/85° C. | 3504 | −35.9% | 344% | 0.0250 |
| 63 | 1.25% | 63 V/85° C. | 3504 | −2.4% | 53.2% | 0.0055 |
| 63 | 0.75% | 63 V/85° C. | 3504 | −2.8% | 56.8% | 0.0040 |
| 63 | 0 | 63 V/85° C. | 3504 | −12.1% | 276% | 0.0950 |
| 80 | 1.25% | 80 V/85° C. | 3504 | −4.6% | 40.0% | 0.0070 |
| 80 | 0.75% | 80 V/85° C. | 3504 | −3.4% | 34.5% | 0.0073 |
| 80 | 0 | 80 V/85° C. | 3504 | — | — | — |
| 100 | 1% | 100 V/85° C. | 3504 | −6.2% | 54.2% | 0.0105 |
| 100 | 0.75% | 100 V/85° C. | 3504 | −3.5% | 31.7% | 0.0097 |
| 100 | 0.5% | 100 V/85° C. | 3504 | −7.1% | 55.7% | 0.0100 |
| 100 | 0.25% | 100 V/85° C. | 3504 | −21.6% | 107% | 0.0110 |
| 100 | 0 | 100 V/85° C. | 3504 | −8.5% | 70.3% | 0.0120 |

TABLE 3
Aging Tests
Copper Only Additive

| | | | | Average | | |
|---|---|---|---|---|---|---|
| Rated | | Test Voltage | | Capacitance | Average ESR | Average |
| Voltage | Cu Conc | and Temp. | Duration | Change | Change | Swelling |
| (volts) | (wt. %) | (volts/° C.) | (hours) | (%) | (%) | (inches) |
| 50 | 4% | 50 V/85° C. | 1000 | −2.7% | 15.0% | 0.0023 |
| 50 | 3% | 50 V/85° C. | 1000 | −2.8% | 15.1% | 0.0030 |
| 50 | 2% | 50 V/85° C. | 1000 | −3.1% | 10.5% | 0.0027 |
| 50 | 1% | 50 V/85° C. | 1000 | −3.0% | 29.5% | 0.0030 |
| 50 | 0.5% | 50 V/85° C. | 1000 | −3.3% | 39.5% | 0.0030 |
| 50 | 0 | 50 V/85° C. | 1000 | −4.8% | 55.3% | 0.0100 |
| 50 | 4% | 50 V/85° C. | 2016 | −2.8% | 15.0% | 0.0030 |
| 50 | 3% | 50 V/85° C. | 2016 | −2.9% | 20.7% | 0.0030 |
| 50 | 2% | 50 V/85° C. | 2016 | −3.5% | 17.5% | 0.0030 |
| 50 | 1% | 50 V/85° C. | 2016 | −3.3% | 36.3% | 0.0030 |
| 50 | 0.5% | 50 V/85° C. | 2016 | −3.6% | 52.6% | 0.0035 |
| 50 | 0 | 50 V/85° C. | 2016 | −7.7% | 111% | 0.0240 |
| 100 | 4% | 100 V/85° C. | 1000 | −0.1% | 7.0% | 0.0033 |
| 100 | 3% | 100 V/85° C. | 1000 | −0.3% | 10.5% | 0.0030 |
| 100 | 2% | 100 V/85° C. | 1000 | −0.6% | 18.0% | 0.0040 |
| 100 | 1% | 100 V/85° C . | 1000 | −0.7% | 22.3% | 0.0037 |
| 100 | 0.5% | 100 V/85° C. | 1000 | −0.8% | 35.7% | 0.0045 |
| 100 | 0 | 100 V/85° C. | 1000 | −1.1% | 40.8% | 0.0185 |
| 100 | 4% | 100 V/85° C. | 2016 | −0.87% | 22.7% | 0.0047 |
| 100 | 3% | 100 V/85° C. | 2016 | −1.1% | 27.2% | 0.0047 |
| 100 | 2% | 100 V/85° C. | 2016 | −1.4% | 38.9% | 0.0060 |
| 100 | 1% | 100 V/85° C. | 2016 | −1.9% | 58.3% | 0.0060 |
| 100 | 0.5% | 100 V/85° C. | 2016 | −1.54% | 52.9% | 0.0060 |
| 100 | 0 | 100 V/85° C. | 2016 | −3.0% | 103% | 0.0510 |

Tables 4-6 show the results of life testing of capacitors according to the first example, capacitors including no transition metal species additive, and capacitors including only one of copper and vanadium as a single transition metal species additive. The entries in these Tables including the “+” symbol indicate that some or all of the capacitors in the tested group were still functioning at the indicated average lifetime. Tables 4-6 all indicate that capacitors including no transition metal additive in the electrolyte have average lifetimes between two and three thousand hours, at most.

Comparing capacitors having similar voltage ratings, it is apparent that capacitors according to the invention, and including both vanadium and copper as transition metal species additives in the electrolyte, have lifetimes that are usually two to five times longer than the lifetime of comparable capacitors including only vanadium as an electrolyte additive. Likewise, capacitor lifetimes, particularly for the lower voltage rated capacitors, are twice as long for capacitors including two transition metal species, namely vanadium and copper, as compared to similar capacitors including only copper as a transition metal additive.

TABLE 4
Life Test
Vanadium + Copper Additive

| Rated | | | Average |
|---|---|---|---|
| Voltage | V Conc | Cu Conc | Lifetime |
| (volts) | (wt. %) | (wt. %) | (hours) |
| 50 | 0.375% | 2% | 8419+ |
| 50 | 0.75% | 3% | 9552+ |
| 50 | 0.75% | 3% | 6325 |
| 80 | 0.375% | 2% | 5762+ |
| 80 | 0.75% | 3% | 6326+ |
| 100 | 0.375% | 2% | 3900 |
| 125 | 0.375% | 2% | 2270+ |
| 50 | 0 | 0 | 2794 |
| 80 | 0 | 0 | 2837 |
| 100 | 0 | 0 | 2760 |
| 125 | 0 | 0 | 2136 |

All capacitors including both vanadium and copper include 0.1 wt. % thiourea.

TABLE 5
Life Test
Vanadium Only Additive

| Rated | | Average |
|---|---|---|
| Voltage | V Conc | Lifetime |
| (volts) | (wt. %) | (hours) |
| 50 | 1.25% | 1631 |
| 50 | 0.25% | 1612 |
| 50 | 0.375% | 2510 |
| 63 | 1.25% | 6690 |
| 63 | 0.75% | 3620 |
| 80 | 1.25% | 3630 |
| 80 | 0.75% | 4278 |
| 125 | 0.125% | 1426 |
| 125 | 0.25% | 1786 |
| 125 | 0.375% | 2016 |
| 50 | 0 | 1949 |
| 63 | 0 | 3264 |
| 80 | 0 | 2016 |
| 125 | 0 | 1478 |

TABLE 6
Life Test
Copper Only Additive

| Rated | | Average |
|---|---|---|
| Voltage | Cu Conc | Lifetime |
| (volts) | (wt. %) | (hours) |
| 50 | 4% | 3936+ |
| 50 | 3% | 3936+ |
| 50 | 2% | 3936+ |
| 50 | 1% | 3936+ |
| 50 | 0.5% | 3936+ |
| 100 | 4% | 3936+ |
| 100 | 3% | 3936+ |
| 100 | 2% | 3936+ |
| 100 | 1% | 3414 |
| 100 | 0.5% | 3936 |
| 100 | 0 | 3024 |

All capacitors containing copper include 0.1 or 0.5 wt. % thiourea.

### Example 2

In the second example of the invention, the transition metal species added to the electrolyte are iron and copper. As in the first example, the compound employed to supply copper is copper sulfate. Iron is preferably supplied by dissolving ferric sulfate (Fe₂ (SO₄)₃) in the electrolyte. The copper concentration was held at 2 wt. % and the iron concentration was varied between 1 wt. % and 4 wt. %. Again, these concentrations were chosen for purposes of testing and are not intended to express fixed ranges to which respective concentrations of the species are restricted in capacitors according to the invention.

Tables 7 and 8 below summarize measured results for capacitors according to the second example with respect to comparative capacitors including only iron as a transition metal species electrolyte additive. Table 3, discussed above, provides information concerning the aging of capacitors including only copper as a single transition metal additive to the electrolyte. Fewer tests were carried out for capacitors according to the second example and many of those tests are still continuing. As a result, some of the data provided in the Tables below is incomplete. All of the aging tests and life tests for capacitors according to the second example and comparative capacitors were carried out at the rated voltage of the capacitors and a temperature of 85° C.

The improvements achieved with capacitors according to the second example, with respect to aging, are, as with the first example, most dramatic with respect to longer tests and changes in ESR. It is apparent from the data provided in Tables 7, 8, and 3, particularly for capacitors with certain rated voltages, that very significant improvements, with the passage of time, are achieved in capacitors according to the second example. The improvements are most noticeable with respect to the rate of increase of ESR. Of course, as expected, the performance of capacitors according to the second example is substantially better than capacitors including no transition metal additives to the electrolyte. In any event, the aging tests confirmed that superior performance is achieved in capacitors according to the invention including a binary mixture of transition metal species, namely iron and copper, in the electrolyte as compared to capacitors that include only one of those two transition metal species as an additive.

The life test data of Tables 9 and 10, as well as Table 6, which pertains to capacitors including copper only as an additive, are less compelling than the data of Tables 4-6 with respect to the first example. As explained above, the life testing of capacitors according to the second example is incomplete so that, as of the filing of this description in the U.S., the improvement achieved in the invention according to the second example is not fully apparent from the Tables. The extended lifetime with respect to capacitors having a rated voltage of 100 volts is somewhat apparent from the limited data available. Further measurements are expected to corroborate, for the second example, the same kind of improvement achieved with respect to the first example.

TABLE 7
Aging Test
Copper + Iron Additive

| | | | | | Average | Average | |
|---|---|---|---|---|---|---|---|
| Rated | Copper | | Test Voltage | | Capacitance | ESR | Average |
| Voltage | Conc | Iron Conc | and Temp. | Duration | Change | Change | Swelling |
| (volts) | (wt. %) | (wt. %) | (volts/° C.) | (hours) | (%) | (%) | (inches) |
| 50 | 2% | 4% | 50 V/85° C. | 1000 | −3.9% | 21.1% | 0.0030 |
| 50 | 2% | 3% | 50 V/85° C. | 1000 | −4.5% | 9.5% | 0.0050 |
| 50 | 2% | 2% | 50 V/85° C. | 1000 | −4.4% | 26.3% | 0.0030 |
| 50 | 2% | 1% | 50 V/85° C. | 1000 | −3.8% | 15.8% | 0.0040 |
| 50 | 0 | 0% | 50 V/85° C. | 1000 | −5.7% | 36.8% | 0.0070 |
| 50 | 2% | 4% | 50 V/85° C. | 1000 | −2.4% | 14.3% | 0.0050 |
| 50 | 2% | 4% | 50 V/85° C. | 2520 | −3.3% | 21.1% | 0.0040 |
| 50 | 2% | 3% | 50 V/85° C. | 2520 | −4.4% | 14.3% | 0.0050 |
| 50 | 2% | 2% | 50 V/85° C. | 2520 | −4.4% | 21.1% | 0.0040 |
| 50 | 2% | 1% | 50 V/85° C. | 2520 | −3.7% | 26.3% | 0.0050 |
| 50 | 0 | 0 | 50 V/85° C. | 2520 | −9.0% | 84.2% | 0.0230 |
| 50 | 2% | 4% | 50 V/85° C. | 3768 | −4.8% | 21.1% | 0.0040 |
| 50 | 2% | 3% | 50 V/85° C. | 3768 | −5.7% | 9.5% | 0.0040 |
| 50 | 2% | 2% | 50 V/85° C. | 3768 | −6.3% | 26.3% | 0.0030 |
| 50 | 2% | 1% | 50 V/85° C. | 3768 | −5.2% | 31.6% | 0.0050 |
| 50 | 0 | 0 | 50 V/85° C. | 3768 | −10.9% | 108% | 0.0375 |
| 100 | 2% | 2% | 100 V/85° C. | 1000 | −0.8% | 13.2% | 0.0040 |
| 100 | 2% | 1% | 100 V/85° C. | 1000 | −1.6% | 27.0% | 0.0040 |
| 100 | 0 | 0 | 100 V/85° C. | 1000 | −2.4% | 50.0% | 0.0250 |
| 100 | 2% | 2% | 100 V/85° C. | 2520 | −1.6% | 15.8% | 0.0070 |
| 100 | 2% | 1% | 100 V/85° C. | 2520 | −3.8% | 48.6% | 0.0080 |
| 100 | 0 | 0 | 100 V/85° C. | 2520 | −6.4% | 169% | 0.0765 |
| 100 | 2% | 2% | 100 V/85° C. | 3768 | −2.9% | 31.6% | 0.0090 |
| 100 | 2% | 1% | 100 V/85° C. | 3768 | −8.0% | 105% | 0.0075 |
| 100 | 0 | 0 | 100 V/85° C. | 3768 | — | — | — |

All capacitors including copper and iron include 0.1 wt. % thiourea.

TABLE 8
Aging Test
Iron Only as Additive

| | | | | Average | | |
|---|---|---|---|---|---|---|
| Rated | | Test Voltage | | Capacitance | Average | Average |
| Voltage | Fe Conc | and Temp. | Duration | Change | ESR | Swelling |
| (volts) | (wt. %) | (volts/° C.) | (hours) | (%) | Change (%) | (inches) |
| 50 | 4% | 50 V/85° C. | 1000 | −4.1% | 20.7% | 0.0007 |
| 50 | 3% | 50 V/85° C. | 1000 | −5.0% | 24.2% | 0.0013 |
| 50 | 2% | 50 V/85° C. | 1000 | −5.1% | 26.3% | 0.0007 |
| 50 | 1% | 50 V/85° C. | 1000 | −5.2% | 28.0% | 0.0013 |
| 50 | 0.5% | 50 V/85° C. | 1000 | −3.9% | 26.3% | 0.0020 |
| 50 | 0 | 50 V/85° C. | 1000 | −5.7% | 36.8% | 0.0060 |
| 50 | 4% | 50 V/85° C. | 2520 | −1.8% | 9.5% | 0.0015 |
| 50 | 4% | 50 V/85° C. | 2520 | −4.1% | 38.1% | 0.0023 |
| 50 | 3% | 50 V/85° C. | 2520 | −5.8% | 45.8% | 0.0016 |
| 50 | 2% | 50 V/85° C. | 2520 | −6.0% | 47.4% | 0.0007 |
| 50 | 1% | 50 V/85° C. | 2520 | −6.3% | 52.6% | 0.0016 |
| 50 | 0.5% | 50 V/85° C. | 2520 | −5.4% | 47.4% | 0.0030 |
| 50 | 4% | 50 V/85° C. | 3768 | −7.0% | 51.8% | 0.0023 |
| 50 | 3% | 50 V/85° C. | 3768 | −7.8% | 50.9% | 0.0017 |
| 50 | 2% | 50 V/85° C. | 3768 | −8.2% | 61.4% | 0.0010 |
| 50 | 1% | 50 V/85° C. | 3768 | −8.5% | 61.4% | 0.0023 |
| 50 | 0.5% | 50 V/85° C. | 3768 | −7.2% | 65.8% | 0.0030 |
| 100 | 1% | 100 V/85° C. | 1000 | −1.1% | 27.5% | 0.0017 |
| 100 | 0.5% | 100 V/85° C. | 1000 | −1.2% | 28.6% | 0.0010 |
| 100 | 0 | 100 V/85° C. | 1000 | −2.4% | 50.0% | 0.0250 |
| 100 | 1% | 100 V/85° C. | 2520 | −2.2% | 67.6% | 0.0045 |
| 100 | 0.5% | 100 V/85° C. | 2520 | −2.3% | 65.7% | 0.0045 |
| 100 | 1% | 100 V/85° C. | 3768 | −3.5% | 82.9% | 0.0075 |
| 100 | 0.5% | 100 V/85° C. | 3768 | −3.5% | 77.1% | 0.0090 |

TABLE 9
Life Test
Copper + Iron Additive

| Rated | Copper | Iron | Average |
|---|---|---|---|
| Voltage | Conc | Conc | Lifetime |
| (volts) | (wt. %) | (wt. %) | (hours) |
| 50 | 2% | 4% | 3768 |
| 50 | 2% | 3% | 3768 |
| 50 | 2% | 3% | 3768 |
| 50 | 2% | 1% | 3768 |
| 100 | 2% | 2% | 3768+ |
| 100 | 2% | 1% | 3768+ |

All capacitors containing copper and iron include 0.1 or 0.5 wt. % thiourea.

TABLE 10
Life Test
Iron Only Additive

| Rated | Iron | Average |
|---|---|---|
| Voltage | Conc | Lifetime |
| (volts) | (wt. %) | (hours) |
| 50 | 4% | 6768 |
| 50 | 3% | 6768 |
| 50 | 2% | 6768 |
| 50 | 1% | 6768+ |
| 50 | 0.5% | 6768 |
| 50 | 0 | 3768 |
| 100 | 1% | 3568 |
| 100 | 0.5% | 3360 |
| 100 | 0 | 2640 |

1. A capacitor comprising:
a cathode;
an anode; and
an electrolyte in contact with the anode and the cathode and including, dissolved within the electrolyte, two different transition metal species, each species having, within the electrolyte, at least two stable oxidation states.

2. The capacitor of claim 1, wherein the transition metal species are selected from the group consisting of copper, vanadium, iron, chromium, cobalt, manganese, mercury, nickel, rhenium, and ruthenium.

3. The capacitor of claim 1, wherein the two different transition metal species are copper and vanadium.

4. The capacitor of claim 3, wherein the electrolyte includes a minor amount of a metal complexing agent.

5. The capacitor of claim 4, wherein the metal complexing agent is thiourea and the thiourea is present in a concentration of about 0.1 wt. percent.

6. The capacitor of claim 3, wherein the electrolyte is an aqueous solution of sulfuric acid.

7. The capacitor according to claim 3, wherein the electrolyte includes, as the transition metal species, vanadium in a concentration in a range from about 0.375 wt. percent to about 0.75 wt. percent, based on weight of a vanadium compound dissolved in the electrolyte, and copper in a concentration in a range from about 2 wt. percent to about 3 wt. percent, based on weight of a copper compound dissolved in the electrolyte.

8. The capacitor of claim 7, wherein the electrolyte includes a minor amount of a metal complexing agent.

9. The capacitor of claim 8, wherein the metal complexing agent is thiourea and the thiourea is present in a concentration of about 0.1 wt. percent.

10. The capacitor of claim 4, wherein the electrolyte is an aqueous solution of sulfuric acid.

11. The capacitor of claim 1, wherein the two different transition metal species are copper and iron.

12. The capacitor of claim 11, wherein the electrolyte includes a minor amount of a metal complexing agent.

13. The capacitor of claim 12, wherein the metal complexing agent is thiourea and the thiourea is present in a concentration of about 0.1 wt. percent.

14. The capacitor of claim 11, wherein the electrolyte is an aqueous solution of sulfuric acid.

15. The capacitor according to claim 11, wherein the electrolyte includes, as the transition metal species, iron in a concentration in a range from about 0.375 wt. percent to about 0.75 wt. percent, based on weight of an iron compound dissolved in the electrolyte, and copper in a concentration in a range from about 2 wt. percent to about 3 wt. percent, based on weight of a copper compound dissolved in the electrolyte.

16. The capacitor of claim 15, wherein the electrolyte includes a minor amount of a metal complexing agent.

17. The capacitor of claim 15, wherein the metal complexing agent is thiourea and the thiourea is present in a concentration of about 0.1 wt. percent.

18. The capacitor of claim 17, wherein the electrolyte is an aqueous solution of sulfuric acid.

19. The capacitor of claim 1 wherein the anode is a porous sintered body of tantalum particles with an oxide coating and the cathode is an electrically conducting metal oxide, and including an ionically conducting separator separating the anode from the cathode.

20. A capacitor comprising:
a cathode comprising an electrically conducting metal oxide;
an anode comprising a porous sintered body of tantalum particles with an oxide coating;
an ionically conducting separator separating the anode from the cathode; and
an electrolyte in contact with the anode and the cathode, the electrolyte comprising an aqueous solution of sulfuric acid, and further including, dissolved within the electrolyte, copper and vanadium.

21. The capacitor according to claim 20, wherein the vanadium is present in a concentration in a range from about 0.375 wt. percent to about 0.75 wt. percent, based on weight of a vanadium compound dissolved in the electrolyte, and the copper is present in a concentration in a range from about 2 wt. percent to about 3 wt. percent, based on weight of a copper compound dissolved in the electrolyte.

22. The capacitor of claim 21, wherein the electrolyte includes a minor amount of a metal complexing agent.

23. The capacitor of claim 22, wherein the metal complexing agent is thiourea and the thiourea is present in a concentration of about 0.1 wt. percent.

24. A capacitor comprising:
a cathode comprising an electrically conducting metal oxide;
an anode comprising a porous sintered body of tantalum particles with an oxide coating;
an ionically conducting separator separating the anode from the cathode; and
an electrolyte in contact with the anode and the cathode, the electrolyte comprising an aqueous solution of sulfuric acid, and further including, dissolved within the electrolyte, copper and iron.

25. The capacitor according to claim 24, wherein the iron is present in a concentration in a range from about 0.375 wt. percent to about 0.75 wt. percent, based on weight of an iron compound dissolved in the electrolyte, and the copper is present in a concentration in a range from about 2 wt. percent to about 3 wt. percent, based on weight of a copper compound dissolved in the electrolyte.

26. The capacitor of claim 25, wherein the electrolyte includes a minor amount of a metal complexing agent.

27. The capacitor of claim 26, wherein the metal complexing agent is thiourea and the thiourea is present in a concentration of about 0.1 wt. percent.
